(19) United States
(12) Patent Application Publication
(10) Pub. No.: US 2014/0059279 A1
(43) Pub. Date: Feb. 27, 2014

(54) SSD Lifetime Via Exploiting Content Locality

(71) Applicant: Virginia Commonwealth University, Richmond, VA (US)

(72) Inventors: Xubin He, Glen Allen, VA (US); Guanying Wu, Richmond, VA (US)

(73) Assignee: Virginia Commonwealth University, Richmond, VA (US)

(21) Appl. No.: 14/010,860

(22) Filed: Aug. 27, 2013

Related U.S. Application Data
(60) Provisional application No. 61/693,485, filed on Aug. 27, 2012.

(51) Int. Cl. G06F 12/02

(52) U.S. Cl. CPC G06F 12/0246
USPC 711/103

(57) ABSTRACT

A solid state drive (SSD), which is used in computing systems, implements the systems and methods of a Delta Flash Transition Layer (ΔFTL) to store compressed data in the SSD instead of original new data. The systems and methods of ΔFTL reduce the write count via exploiting the content locality between the write data and its corresponding old version in the flash. Content locality implies the new version resembles the old to some extent, so that the difference (delta) between the versions may be compressed compactly. Instead of storing new data in its original form in the flash, ΔFTL stores the compressed deltas.

### CROSS-REFERENCE TO RELATED APPLICATIONS

This application claims the benefit of U.S. Provisional Patent Application No. 61/693,485, entitled “Delta-FTL: A Novel Design to Improve SSD Lifetime via Exploiting Content Locality,” filed on Aug. 27, 2012, and which is incorporated herein by reference.

### BACKGROUND OF THE INVENTION

1. Field of the Invention

The present invention generally relates to solid state drives (SSDs) used in computing systems and, more particularly, to the use of a Delta Flash Transition Layer (ΔFTL) to store compressed data in the SSD instead of original new data in order to reduce the number of writes committed to flash.

2. Background Description

Solid state drives (SSDs) exhibit good performance, particularly for random workloads, compared to traditional hard drives (HDDs). From a reliability standpoint, SSDs have no moving parts, no mechanical wear-out, and are silent and resistant to heat and shock. However, the limited lifetime of SSDs is a major drawback that hinders their deployment in reliability sensitive environments. The reliability problem of SSDs mainly comes from the following facts. Flash memory must be erased before it can be written and it may only be programmed/erased for a limited times (5K to 100K). In addition, the out-of-place writes result in invalid pages to be discarded by garbage collection (GC). Extra writes are introduced in GC operations to move valid pages to a clean block which further aggravates the lifetime problem of SSDs.

Existing approaches for this problem mainly focus on two perspectives: (1) to prevent early defects of flash blocks by wear-leveling techniques; and (2) to reduce the number of write operations on the flash. For the latter, various techniques are proposed including in-drive buffer management schemes to exploit the temporal or spatial locality, FTLs (Flash Translation Layer) to optimize the mapping policies or garbage collection schemes to reduce the write-amplification factor, or data deduplication to eliminate writes of existing content in the drive.

The NAND flash by itself exhibits relatively poor performance. The high performance of an SSD comes from leveraging a hierarchy of parallelism. At the lowest level is the page, which is the basic unit of I/O read and write requests in SSDs. Erase operations operate at the block level, which are sequential groups of pages. A typical value for the size of a block is 64 or 128 pages. Further up the hierarchy is the plane, and on a single die there could be several planes. Planes operate semi-independently, offering potential speed-ups if data is striped across several planes. Additionally, certain copy operations can operate between planes without crossing the I/O pins. An upper level of abstraction, the chip interfaces, free the SSD controller from the analog processes of the basic operations, i.e., read, program, and erase, with a set of defined commands. NAND interface standards includes ONFI, BA-NAND, OneNAND, LBA-NAND, etc. SSDs hide the underlying details of the chip interfaces and exports the storage space as a standard block-level disk via a software layer called Flash Translation Layer (FTL). FTL is a key component of an SSD in that it is not only responsible for managing the “logical to physical” address mapping but also works as a flash memory allocator, wear-leveler, and garbage collection engine. The mapping policies of FTLs can be classified into two types: page-level mapping, where a logical page can be placed onto any physical page; or block-level mapping, where the logical page LBA is translated to a physical block address and the offset of that page in the block.

In attempts to extend the lifetime of SSDs, many designs have been proposed in the literature such as FTLs, cache schemes, hybrid storage materials, etc.

FTLs: For block-level mapping, several FTL schemes have been proposed to use a number of physical blocks to log the updates. Examples include FAST, BAST, SAST, and LAST. The garbage collection of these schemes involves three types of merge operations, full, partial, and switch merge. The block-level mapping FTL schemes leverage the spatial or temporal locality in write workloads to reduce the overhead introduced in the merge operations. For page level mapping, DFTL is proposed to cache the frequently used mapping table in the in-drive SRAM so as to improve the address translation performance as well as reduce the mapping table updates in the flash; μ-FTL adopts the μ-tree on the mapping table to reduce the memory footprint. Two-level FTL is proposed to dynamically switch between page-level and block-level mapping. Content-aware FTLs (CAFTL) implement the deduplication technique as FTL in SSDs to eliminate contents that are “exactly” the same across the entire drive. CAFTL requires complicated FTL design and implementation, e.g., a large finger-print store to facilitate content lookup and multi-layer mapping tables to locate logical addresses associated to the same content. Due to the limited computation power of the micro-processor inside SSDs, the complexity of deduplication via CAFTL is a major concern.

Cache schemes: A few in-drive cache schemes like BPLRU, FAB, CLC, and BPAC are proposed to improve the sequentiality of the write workload sent to the FTL, in hopes of reducing the merge operation overhead on the FTLs. CFLRU which works as an OS level scheduling policy, chooses to prioritize the clean cache elements when doing replacements so that the write operations can be reduced or avoided. Taking advantage of fast sequential performance of HDDs, it has been proposed to extend the SSD lifetime by caching SSDs with HDDs.

Heterogeneous material: Utilizing advantages of PCRAM, such as the in-place update ability and faster access, G. Sun et al., in “A hybrid solid-state storage architecture for the perform and, energy consumption, and lifetime improvement,” (Proceedings of HPCA-16, pp. 141-153) describe a hybrid architecture to log the updates on PCRAM for flash. FlexFS on the other hand, combines MLC and SLC as trading off the capacity and erase cycle.

Wear-leveling Techniques: Dynamic wear-leveling techniques try to recycle blocks of small erase counts. To address the problem of blocks containing cold data, static wear-leveling techniques try to evenly distribute the wear over the entire SSD.

In general, the content locality implies that the data in the system share similarity with each other. Such similarity can be exploited to reduce the memory or storage usage by delta-encoding the difference between the selected data and its reference. Content locality has been leveraged in various levels of the system. In virtual machine (VM) environments, VMs share a significant number of identical pages in the memory, which can be deduplicated to reduce the memory system pressure. Difference engine improves the performance over deduplication by detecting the nearly identical pages and coalesce them via in-core compression into much smaller memory footprint. Difference engine detects similar pages based on hashes of several chucks of each page: hash collisions are considered as a sign of similarity. Different from difference engine, GLIMPSE and DERD system work on the file system to leverage similarity across files; the similarity detection method adopted in these techniques is based on Rabin fingerprints over chunks at multiple offsets in a file. In the block device level, Peabody and TRAP-Array are proposed in attempts to reduce the space overhead of storage system backup, recovery, and rollback via exploiting the content locality between the previous (old) version of data and the current (new) version. Peabody mainly focuses on eliminating duplicated writes, i.e., the update write contains the same data as the corresponding old version (silent write) or sectors at different location (coalesced sectors). On the other hand, TRAP-Array reduces the storage usage of data backup by logging the compressed XORs (delta) of successive writes to each data block. The intensive content locality in the block I/O workloads produces a small compression ratio on such deltas and TRAP-Array is significantly space-efficient compared to traditional approaches. I-CASH takes the advantage of content locality existing across the entire drive to reduce the number of writes in the SSDs. I-CASH stores only the reference blocks on the SSDs while logs the delta in the HDDs.

### SUMMARY OF THE INVENTION

Exemplary embodiments of the present invention are methods and systems to efficiently solve the lifetime issue of SSDs with a new FTL scheme, ΔFTL. ΔFTL reduces the write count via exploiting the content locality. The content locality may be observed and exploited in memory systems, file systems, and block devices. Content locality means data blocks, either blocks at distinct locations or created at different time, share similar contents.

In a preferred embodiment of the present invention, the content locality is exploited that exists between the new (the content of update write) and the old version of page data mapped to the same logical address. This content locality implies the new version resembles the old to some extent, so that the difference (delta) between them may be compressed compactly. Instead of storing new data in its original form in the flash, ΔFTL stores the compressed deltas to reduce the number of writes.

Additional exemplary embodiments of the invention are methods and systems for ΔFTL to extend SSD lifetime via exploiting the content locality. The ΔFTL functionality may be achieved from the data structures and algorithms that enhance the regular page-mapping FTL. The ΔFTL includes techniques to alleviate the potential performance overheads. For example, ΔFTL favors certain workload characteristics to improve ΔFTL's performance on extending SSD's lifetime.

In another preferred embodiment of the invention, ΔFTL exploits the content locality between new and old versions of data. ΔFTL aims at reducing the number of program/erase (P/E) operations committed to the flash memory so as to extend SSD's lifetime. The history data is considered “invalid” and discarded in ΔFTL. ΔFTL is an embedded software in the SSD to manage the allocation and de-allocation of flash space, which requires relative complex data structures and algorithms that are “flash-aware.” It also requires that the computation complexity should be kept minimum due to limited micro-processor capability.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is block diagram illustrating a solid state drive connected to a host computer according to the invention;

FIG. 2 is a block diagram illustrating an overview the ΔFTL according to the invention;

FIG. 3 is a block diagram of the ΔFTL Temp Buffer;

FIG. 4 is a time line illustrating the ΔFTL delta-encoding process;

FIG. 5 is a block diagram illustrating the ΔFTL mapping entry;

FIG. 6(a) and FIG. 6(b), taken together, illustrate the ΔFTL buffered mapping entry;

FIG. 7 is a block diagram of the ΔFTL dispatching policy; and

FIG. 8 is a block diagram illustrating a computer system within which a set of instructions, for causing the SSD or any of its components to perform any one or more of the methodologies and operations of the invention, may be executed.

### DETAILED DESCRIPTION THE INVENTION

It is understood that specific embodiments are provided as examples to teach the broader inventive concept, and a person having ordinary skill in the art can easily apply the teachings of the present disclosure to other methods and systems. Also, it is understood that the methods and systems discussed in the present disclosure include some conventional structures and/or steps. Since these structures and steps are well known in the art, they will only be discussed in a general level of detail. Furthermore, reference numbers are repeated throughout the drawings for the sake of convenience and example, and such repetition does not indicate any required combination of features or steps throughout the drawings.

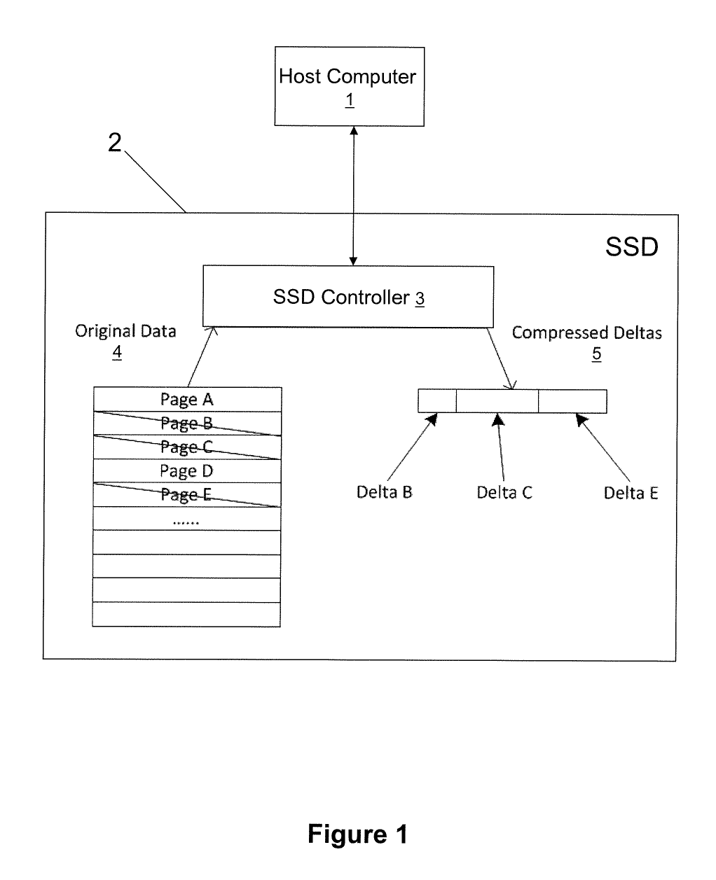

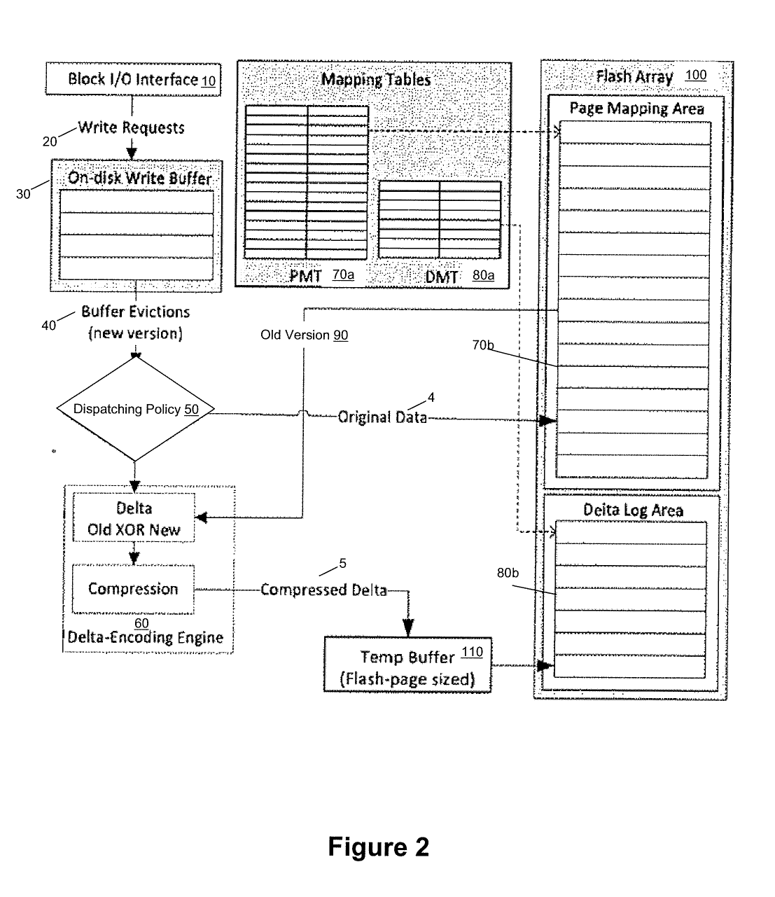

FIG. 1 illustrates a host computer 1 connected to a SSD 2. The host computer 1 is configured to send write requests to SSD 2. SSD 2 includes a controller 3 configured to operate in accordance with the architecture of ΔFTL, which is depicted in detail in FIG. 2. ΔFTL is designed as a flash management scheme that stores the write data from write requests 20 in form of compressed deltas 5 on the flash array 100. Instead of devising from scratch, ΔFTL is rather an enhancement to the framework of the conventional page-mapping FTL techniques as discussed above in Section Background of the Invention.

FIG. 2 gives an overview of ΔFTL and unveils its major differences from a typical page-mapping FTL. First, ΔFTL has a dedicated area, delta log area (DLA) 80b, for logging the compressed deltas 5. Second, the compressed deltas 5 must be associated with their corresponding old versions 90 to retrieve the data. An extra mapping table, delta mapping table (DMT) 80a, collaborates with page mapping table (PMT) 70a to achieve this functionality. Third, ΔFTL has a delta-encoding engine 60 to derive and then compress the delta 5 between the write buffer evictions 40 and their old version 90 on the flash array 100.

A dispatching policy 50 determines whether a write request 20 is stored in its original form or in its “delta-XOR-old” form. For the first case, the original data 4 is written to a flash page in page mapping area 70b in its original form. For the latter case, the delta-encoding engine 60 derives and then compresses the delta 5 between old and new. The compressed deltas 5 are buffered in a flash-page-sized temp buffer 110 until the buffer is full. Then, the content of the temp buffer 110 is committed to a flash page in delta log area 80b.

Details of the data structures and algorithms to implement ΔFTL are given in the following subsections.

### Dispatching Policy: Delta Encode?

The content locality between the new version 40 and old version 90 of the data allows the delta-encoding engine 60 to compress the delta 5, which has rich information redundancy, to a compact form. Writing the compressed deltas 5 rather than the original data, would indeed reduce the number of flash writes. However, delta-encoding all data indiscriminately would cause overheads.

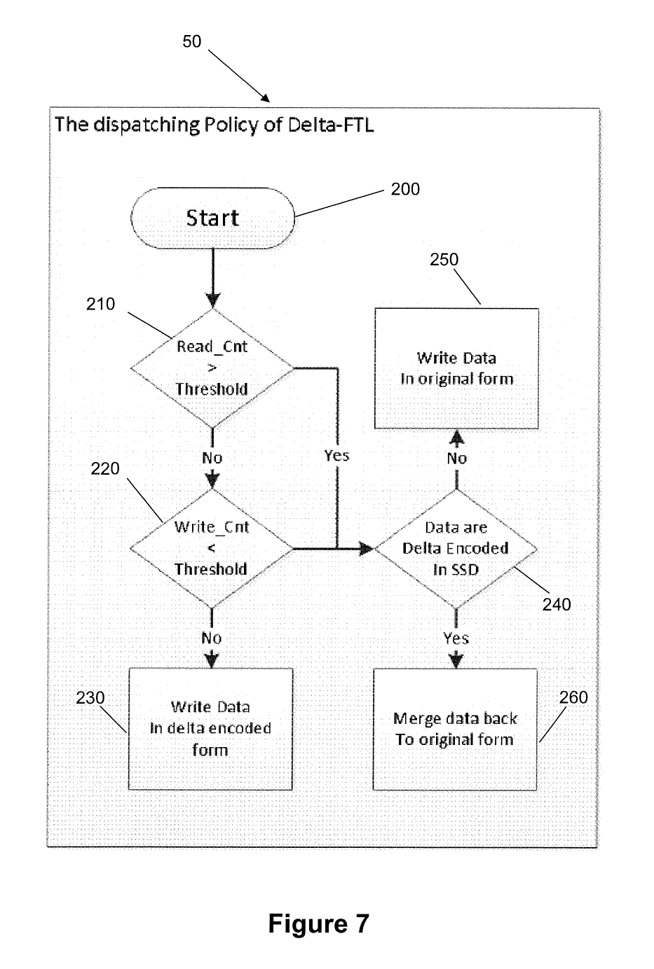

First, if a page is stored in “delta-XOR-old” form, this page actually requires storage space for both delta 5 and the old version 90, compared to only one flash page if in the original form. The extra space is provided by the over-provisioning area of the drive. To make a trade-off between the over-provisioning resource and the number of writes, ΔFTL favors the data that are overwritten frequently. This dispatching policy 50 may be interpreted intuitively, by way of the following non-limiting example, in a workload, page data A is only overwritten once while B is overwritten 4 times. Assuming the compression ratio is 0.25 in the example, delta-encoding A would reduce the number of write by ¾ page (compared to the baseline which would take one page write) at a cost of ¼ page in the over-provision space. Delta-encoding B, on the other hand in the example, reduces the number of write by 4×(¾)=3 pages at the same cost of space. Clearly, better performance/cost ratio is achieved with such write “hot” data rather than the cold ones. The approach taken by ΔFTL to differentiate hot data from cold ones is discussed below in Section Cache Mapping Table In the RAM, and illustrated by FIG. 7.

Second, fulfilling a read request targeting a page in “delta-XOR-old” form requires two flash page reads. This may have reverse impact on the read latency. To alleviate this overhead, ΔFTL avoids delta-encoding pages that are read intensive. If a page in “delta-XOR-old” form is found read intensive, ΔFTL will merge it to the original form to avoid the reading overhead. Again, the detailed approach is depicted in FIG. 7 and discussed below in Section Cache Mapping Table In the RAM.

Third, the delta-encoding process involves operations to fetch the old version 90, derive and compress delta 5. This extra time may potentially add overhead to the write performance (discussed in Section Write Performance Overhead). ΔFTL must cease delta-encoding if it would degrade the write performance.

To summarize, ΔFTL delta-encodes data that are write-hot but read-cold while ensuring the write performance is not degraded.

### Write Buffer and Delta-Encoding

The on-disk write buffer 30 resides in the volatile memory (SRAM or DRAM) managed by an SSD's internal controller 3 and shares a significant portion of it. The write buffer 30 absorbs repeated writes and improves the spatial locality of the output workload from it. The write buffer 30 is connected to the block input/output interface 10. Write requests 20 are received from the host computer 1 via the I/O interface 10. When buffer eviction 40 occurs, the evicted write pages are dispatched according to our dispatching policy 50 to either ΔFTL's delta-encoding engine 60 or directly to the page mapping area 70b of the page mapping table 70a.

Delta-encoding engine 60 takes the new version of the page data (i.e., the evicted page) and the corresponding old version 90 in page mapping area 70b, as its inputs. It derives the delta by XOR the new and old version and then compress the delta. The compressed delta 5 are buffered in temp buffer 110.

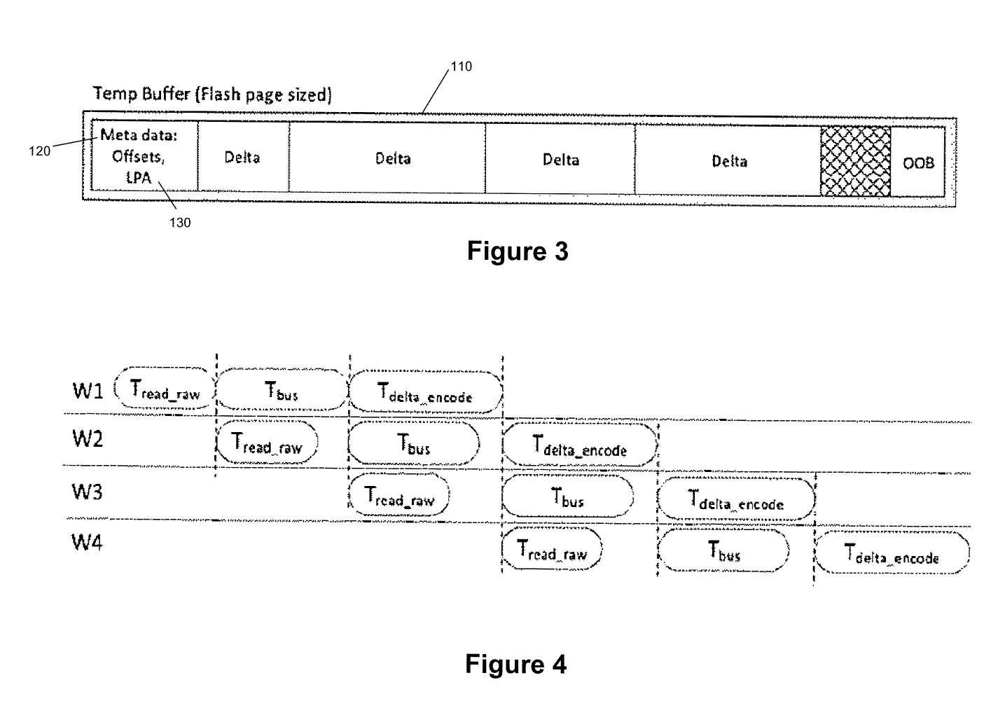

Temp buffer 110 is of the same size as a flash page. Its content will be committed to delta log area 80b once it is full or there is no space for the next compressed delta 5. Splitting a compressed delta 5 on two flash pages would involve in unnecessary complications for ΔFTL. Storing multiple deltas 5 in one flash page requires meta-data 120, like LPA (logical page address) and the offset of each delta 5 (as shown in FIG. 3) in the page, to associate them with their old versions 90 and locate the exact positions. The meta-data 120 is stored at the MSB part of a page instead of attached after the deltas 5, for the purpose of fast retrieval. This is because the flash read operation always buses out the content of a page from its beginning. The content of temp buffer 110 described here is essentially the flash pages of delta log area 80b.

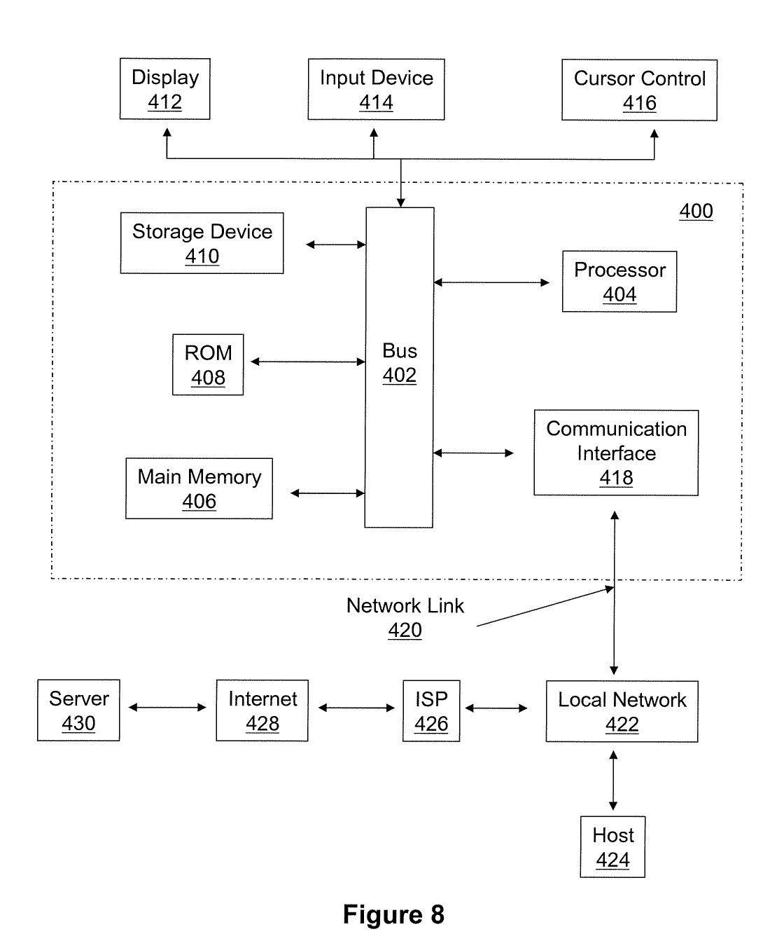

Delta-encoding engine 60 demands the computation power of SSD's 2 internal micro-processor (see FIG. 8 for a more detailed discussion) and would introduce overhead for write requests 20. The delta-encoding latency is discussed in detail in Section Delta-encoding Latency and the approach adopted by ΔFTL to control the overhead in Section Write Performance Overhead.

### Delta-Encoding Latency

Delta-encoding involves two steps: to derive delta (XOR the new and old versions) and to compress it. Among many data compression algorithms, the lightweight ones are advantageous for ΔFTL due to the limited computation power of the SSD's internal micro-processor. The latency of a few exemplary algorithms, including Bzip2, LZO, LZF, Snappy, and Xdelta, were investigated by emulating the execution of them on the ARM platform: the source codes are cross-compiled and run on the SimpleScalar-ARM simulator. The simulator is an extension to SimpleScalar supporting ARM7 architecture and a processor similar to ARM®Cortex R4, which inherits ARM7 architecture. For each algorithm, the number of CPU cycles is reported and the latency is then estimated by dividing the cycle number by the CPU frequency. By way of example, LZF (LZF1X-1) is a good trade-off between speed and compression performance, plus a compact executable size. The average number of CPU cycles for LZF to compress and decompress a 4 KB page is about 27212 and 6737, respectively. According to Cortex R4's write paper, it can run at a frequency from 304 MHz to 934 MHz. The latency values in μs are listed in Table 1. An intermediate frequency value (619 MHz) is included along with the other two to represent three classes of micro-processors in SSDs.

TABLE 1
Delta-encoding Latency

| | Frequency (MHz) | | |
|---|---|---|---|
| | 304 | 619 | 934 |
| Compression (μs) | 89.5 | 44.0 | 29.1 |
| Decompression (μs) | 22.2 | 10.9 | 7.2 |

### Write Performance Overhead

ΔFTL's delta-encoding is a two-step procedure. First, delta-encoding engine 60 fetches the old version 90 from the page mapping area 70b. Second, the delta 5 between the old and new data are derived and compressed. The first step consists of raw flash access and bus transmission, which exclusively occupy the flash chip and the bus to the micro-processor, respectively. The second step occupies exclusively the micro-processor to perform the computations. Naturally, these three elements, the flash chip, the bus, and micro-processor, forms a simple pipeline (see FIG. 8), where the delta-encoding procedures of a serial of write requests 20 could be overlapped. An example of four writes is demonstrated in FIG. 4, where T_{delta}_{_{—}}_{encode} is the longest phase. This is true for a micro-processor of 304 MHz or 619 MHz assuming T_{read}_{_{—}}_{jaw} and T_{bus} take 25 μs and 40 μs (Table 3), respectively. A list of symbols used in this section is summarized in Table 2.

TABLE 2
List of Symbols

| | |
|---|---|
| n | Number of pending write pages |
| P_{c} | Probability of compressible writes |
| R_{c} | Average compression ratio |
| T_{write} | Time for page write |
| T_{read}_{_{—}}_{raw} | Time for raw flash read access |
| T_{bus} | Time for transferring page via bus |
| Tₑᵣₐₛₑ | Time to erase block |
| T_{delta}_{_{—}}_{encode} | Time for delta-encoding a page |
| Bₛ | Block size (pages/block) |
| N | Total number of page writes in the workload |
| T | Data blocks containing invalid pages (baseline) |
| t | Data blocks containing invalid pages (ΔFTL's PMA) |
| PE_{gc} | Number of P/E operations done in GC |
| F_{gc} | GC frequency |
| OH_{gc} | Average GC overhead |
| G_{gc} | Average GC gain (number of invalid pages |
| | reclaimed) |
| S_{cons} | Consumption speed of available clean blocks |

For an analytical view of the write overhead, we assume there is a total number of n write requests 20 pending for a chip. Among these requests, the percentage that is considered compressible according to the dispatching policy 50 is P_{c} and the average compression ratio is R_{c}. The delta-encoding procedure for these n requests takes a total time of: MAX(T_{read}_{_{—}}_{raw}, T_{bus}, T_{delta}_{_{—}}_{encode})×n×Pc. The number of page writes committed to the flash is the sum of original data 4 writes and compressed delta 5 writes: (1−P_{c})×n+P_{c}×n×R_{c}. For the baseline, which always outputs the data in their original form, the page write total is n. We define that the write overhead exists if ΔFTL's write routine takes more time than the baseline. Thus, there is no overhead if the following expression is true:

MAX(T_{read raw}, T_{bus}, T_{delta encode})×n×P+((1−P_{c})×n+P_{c}×n×R_{c})×T_{write}<n×T_{write} (1)

Expression 1 can be simplified to:

$$1 - {R}_{c} > \frac{MAX ( {T}_{read {raw}^{′ }} {T}_{{bus}^{′}} {T}_{delta encode} )}{{T}_{write}} \qquad ( 2 )$$

Substituting the numerical values in Table 1 and Table 3, the right side of Expression 2 is 0.45, 0.22, and 0.20, for micro-processor running at 304, 619, and 934 MHz, respectively. Therefore, the viable range of R_{c} should be smaller than 0.55, 0.78, and 0.80. Clearly, a high performance micro-processor would impose a less restricted constraint on R_{c}. If R_{c} is out of the viable range due to weak content locality in the workload, in order to eliminate the write overhead, ΔFTL may switch to the baseline mode where the delta-encoding procedure is bypassed.

### Flash Allocation

ΔFTL's flash allocation scheme is an enhancement to the conventional page mapping FTL scheme with a number of flash blocks dedicated to store the compressed deltas 5. These blocks are referred to as delta log area (DLA) 80b. Similar to page mapping area (PMA) 70b, a clean block for DLA 80b is allocated so long as the previous active block is full. The garbage collection policy will be discussed in Section Garbage Collection. DLA 80b cooperates with PMA 70b to render the latest version of one data page if it is stored as delta-XOR-old form. Obviously, read requests for such data page would suffer from the overhead of fetching two flash pages. To alleviate this problem, we keep the track of the read access popularity of each delta. If one delta is found read-popular, it is merged with the corresponding old version and the result (data in its original form) is stored in PMA 70b. Furthermore, as discussed in Section Dispatching Policy: Delta Encode?, write-cold data should not be delta-encoded in order to save the over-provisioning space. Considering the temporal locality of a page may last for only a period in the workload, if a page previously considered write-hot is no longer demonstrating its temporal locality, this page should be transformed to its original form from its delta-XOR-old form. ΔFTL periodically scans the write-cold pages and merges them to PMA 70b from DLA 80b if needed.

### Mapping Table

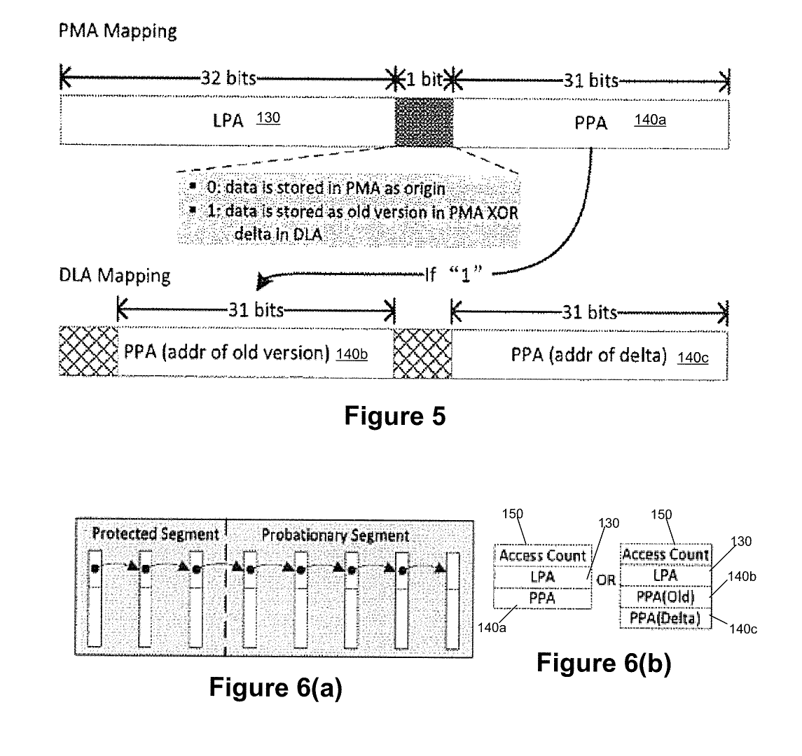

The flash management scheme discussed above requires ΔFTL to associate each valid delta 5 in DLA 80b with its old version 90 in PMA 70b. ΔFTL adopts two mapping tables for this purpose: page mapping table (PMT) 70a and delta mapping table (DMT) 80a. Page mapping table 70a is the primary table indexed by logical page address (LPA) 130 of 32 bits. For each LPA, PMT 70a maps it to a physical page address (PPA) 140a in page mapping area 70b, either the corresponding data page is stored as its original form or in delta-XOR-old form. For the later case, the PPA 140a points to the old version 90. PMT 70a differentiates these two cases by prefixing a flag bit to the 31 bits PPA 140a (which can address 8 TB storage space assuming a 4 KB page size). As demonstrated in FIG. 5: if the flag bit is “1,” which means this page is stored in delta-XOR-old form, we use the PPA (addr of the old version) 140b to consult the delta mapping table 80a and find out on which physical page the corresponding delta 5 resides. Otherwise, the PPA 140a in this page mapping table entry points to the original form of the page. DMT 80a does not maintain the offset information of each delta in the flash page; we locate the exact position with the metadata 120 prefixed in the page (as depicted in FIG. 3).

### Store Mapping Tables on the Flash

ΔFTL stores both mapping tables 70a, 80a on the flash array 100 and keeps a journal of update records for each table 70a, 80a. The updates are first buffered in the in-drive RAM and when they grow up to a full page, these records are flushed to the journal on the flash. In case of power failure, a built-in capacitor or battery in the SSD 2 (e.g., a SuperCap) may provide the power to flush the un-synchronized records to the flash array 100. The journals are merged with the tables 70a, 80a periodically.

### Cache Mapping Table in the RAM

ΔFTL adopts the same idea of caching popular table entries in the RAM as DFTL, as shown in FIG. 6(a). The cache is managed using segment LRU scheme (SLRU). Different from two separate tables on the flash, the mapping entries for data either in the original faun or delta-XOR-old form are included in one SLRU list. For look-up efficiency, all entries are indexed by the LPA 130. Particularly, entries for data in delta-XOR-old form associate the LPA 130 with PPA of old version 140b and PPA of delta 140c, as demonstrated in FIG. 6(b). If an address look-up miss occurs in the mapping table cache and the target page is in delta-XOR-old form, both on-flash tables are consulted and the information is merged together to an entry as shown in FIG. 6(b).

As discussed in Section Flash Allocation, the capability of differentiating write-hot and read-hot data is critical to ΔFTL. Delta-encoding the write-cold or read-hot data and merging the delta and old version of one page if it is found read-hot or found no longer write-hot must be avoided. To keep track of read/write access frequency, each mapping entry in the cache is associated with an access count 150. If the mapping entry of a page is found having a read-access (or write-access) count larger or equal to a predefined threshold, we consider this page read-hot (or write-hot) and vice versa. For example, the threshold may be set as 2.

This information is forwarded to the dispatching policy 50 to guide the destination of a write request 20. FIG. 7 illustrates an exemplary embodiment of the ΔFTL dispatching policy. For example, at start 210, if a write request 20 has a read access count less than a predefined threshold 210 and a write access count greater than the predefined threshold 220, it will be favored and its data written in delta encoded form 230. On the other hand, if, at start 210, a write request 20 has a read access count greater than a predefined threshold 210 and a write access count less than the threshold 220, merge operations 260 take place if needed based on a determination 240 of whether its data are encoded in the SSD 2. If a corresponding old version is found at determination 240, the write request 20 is merged with the corresponding old version resulting in data in its original form 260. On the other hand, the data is written in original faun 250.

### Garbage Collection

Overwrite operations causes invalidation of old data, which the garbage collection (GC) engine is required to discard when clean flash blocks are short. GC engine copies the valid data on the victim block to a clean one and erase the victim thereafter. ΔFTL selects victim blocks based on a simple “greedy” policy, i.e., blocks having the most number of invalid data result in the least number of valid data copy operations and the most clean space reclaimed. ΔFTL's GC victim selection policy does not differentiate blocks from page mapping area 70b or delta log area 80b. In delta log area 80b, the deltas 5 becomes invalid in the following scenarios:
1. If there is a new write considered not compressible (the latest version will be dispatched to PMA 70b), according to the dispatching policy 50, the corresponding delta 5 of this request and the old version 90 in PMA 70b become invalid.
2. If the new write is compressible and thus a new delta 5 for the same LPA 130 is to be logged in DLA 80b, the old delta 5 becomes invalid.
3. If this delta 5 is merged with the old version 90 in PMA 70b, either due to read-hot or write-cold, it is invalidated.
4. If there is a TRIM command indicating that a page is no longer in use, the corresponding delta 5 and the old version 90 in PMA 70b are invalidated. The TRIM command informs a SSD 2 which pages of data are no longer considered in use and can be marked as invalid. Such pages are reclaimed so as to reduce the no-in-place-write overhead caused by subsequent overwrites.
   For any case, ΔFTL maintains the information about the invalidation of the deltas 5 for GC engine to select the victims. In order to facilitate the merging operations, when a block is selected as GC victim, the GC engine will consult the mapping table 70a, 80a for information about the access frequency of the valid pages in the block. The GC engine will conduct necessary merging operations while it is moving the valid pages to the new position. For example, for a victim block in PMA 70b, GC engine finds out a valid page is associated with a delta 5 which is read-hot, then this page will be merged with the delta 5 and mark the delta 5 as invalidated.

### SSD Lifetime Extension of ΔFTL

Analytical discussion about ΔFTL's performance on SSD 2 lifetime extension is given in this section. The number of program and erase (P/E) operations executed to service the write requests is used as the metric to evaluate the lifetime of SSDs 2. This is a well-known practice in the art, particularly for work related to targeting SSD 2 lifetime improvement. This is because the estimation of SSDs' 2 lifetime is very challenging due to many complicated factors that would affect the actual number of write requests 20 an SSD 2 could handle before failure, including implementation details the device manufacturers would not unveil. On the other hand, comparing the P/E counts resulted from our approach to the baseline is relatively a more practical metric for the purpose of performance evaluation.

Write amplification is a well-known problem for SSDs 2: due to the out-of-place-update feature of NAND flash, the SSDs 2 have to take multiple flash write operations (and even erase operations) in order to fulfill one write request 20. There are a few factors that would affect the write amplification, e.g., the write buffer 30, garbage collection, wear leveling, etc. As an example, discussion of the garbage collection is provided, assuming the other factors are the same for ΔFTL and the conventional page mapping FTLs. The total number of P/E operations may be divided into two parts: the foreground writes issued from the write buffer 30 (for the baseline) or ΔFTL's dispatcher and delta-encoding engine 60; the background page writes and block erase operations involved in GC processes. Symbols introduced in this section are listed in Table 2 above.

### Foreground Page Writes

Assuming for one workload, there is a total number of N page writes issued from the write buffer 30. The baseline has N foreground page writes while ΔFTL has (1−P_{c})×N+P_{c}×N×R_{c} (as discussed in Section Write Overhead). ΔFTL would resemble the baseline if P_{c} (percentage of compressible writes) approaches 0 or R_{c} (average compression ratio of compressible writes) approaches 1, which means the temporal locality or content locality is weak in the workload.

### GC Caused P/E Operations

The P/E operations caused by GC processes is essentially determined by the frequency of GC and the average overhead of each GC, which can be expressed as:

PE_{gc} ∝ F_{gc}×OH_{gc} (3)

GC process is triggered when clean flash blocks are short in the drive. Thus, the GC frequency is proportional to the consumption speed of clean space and inversely proportional to the average number of clean space reclaimed of each GC (GC gain):

$${F}_{gc} ∝ \frac{{S}_{cons}}{{G}_{gc}} \qquad ( 4 )$$

Consumption Speed is actually determined by the number of foreground page writes (N for the baseline). GC Gain is determined by the average number of invalid pages on each GC victim block.

### GC P/E of the Baseline

In consideration of the baseline, assume for the given workload, all write requests are overwrites to existing data in the drive, then N page writes invalidate a total number of N existing pages. If these N invalid pages spread over T data blocks, the average number of invalid pages (thus GC Gain) on GC victim blocks is N/T. Substituting into Expression 4, we have the following expression for the baseline:

$${F}_{gc} ∝ \frac{N}{N / T} = T \qquad ( 5 )$$

For each GC, we have to copy the valid pages (assuming there are Bₛ pages/block, we have Bₛ−N/T valid pages on each victim block on average) and erase the victim block. Substituting into Expression 3:

PE_{gc} ∝ T×(Erase+Program×(Bₛ−N/T)) (6)

### GC P/E of ΔFTL

Now, in consideration ΔFTL's performance, among N page writes issued from the write buffer 30, (1−P_{c})×N pages are committed in PMA 70b causing the same number of flash pages in PMA 70b to be invalidated. Assuming there are t blocks containing invalid pages caused by those writes in PMA 70b, we apparently have t≦T. The average number of invalid pages in PMA 70b is then (1−P_{c})×N/t. On the other hand, P_{c}×N×R_{c} pages containing compressed deltas 5 are committed to DLA 80b. Recall that there are three scenarios where the deltas 5 in DLA 80b get invalidated (see Section Garbage Collection). Omitting the last scenario which is rare compared to the first two, the number of deltas 5 invalidated is determined by the overwrite rate (P_{ow}) of deltas 5 committed to DLA 80b: while we assume in the workload all writes are overwrites to existing data in the drive, this overwrite rate here defines the percentage of deltas that are overwritten by the subsequent writes in the workload. For example, no matter the subsequent writes are incompressible and committed to PMA 70b or otherwise, the corresponding delta 5 gets invalidated. The average invalid space (in the term of pages) of victim block in DLA 80b is thus P_{ow}×Bₛ. Substituting these numbers to Expression 4: If the average GC gain in PMA 70b outnumbers that in DLA 80b, we have:

$${F}_{gc} ∝ \frac{( 1 - {P}_{c} + {P}_{c} {R}_{c} ) N}{( 1 - {P}_{c} ) N / t} = t ( 1 + \frac{{P}_{c} {R}_{c}}{1 - {P}_{c}} ) \qquad ( 7 )$$

Otherwise, we have:

$${F}_{gc} ∝ \frac{( 1 - {P}_{c} + {P}_{c} {R}_{c} ) N}{{P}_{ow} {B}_{s}} \qquad ( 8 )$$

Substituting Expression 7 and 8 to Expression 3, we have for GC introduced P/E:

$$\begin{matrix}{PE}_{gc} ∝ t ( 1 + \frac{{P}_{c} {R}_{c}}{1 - {P}_{c}} ) \times ( Erase + Program \times ( {B}_{s} - ( 1 - {P}_{c} ) N / t ) ) \\ or \text{:} & ( 9 ) \\ {PE}_{gc} ∝ \frac{( 1 - {P}_{c} + {P}_{c} {R}_{c} ) N}{{P}_{ow} {B}_{s}} \times ( {T}_{erase} + {T}_{write} \times {B}_{s} ( 1 - {P}_{ow} ) ) & ( 10 )\end{matrix}$$

From the above discussions, it is demonstrated, by way of example, that ΔFTL favors the disk I/O workloads that demonstrate: (i) high content locality that results in small R_{c}; and (ii) high temporal locality for writes that results in large P_{c} and P_{ow}. Such workload characteristics are widely present in various OLTP applications such as TPC-C, TPC-W, etc.

The performance of ΔFTL under real-world workloads have been evaluated via simulation experiments. Results show that ΔFTL significantly extends SSD's lifetime by reducing the number of garbage collection (GC) operations at a cost of trivial overhead on read latency performance. Specifically, ΔFTL results in 33% to 58% of the baseline garbage collection operations; and the read latency is only increased by approximately 5%.

### Computer System

FIG. 8 is a block diagram illustrating a computer system 400 within which a set of instructions, for causing the SSD 2 or any of its components to perform any one or more of the methodologies and operations discussed herein, may be executed. Computer system 400 includes a bus 402 or other communication mechanism for communicating information, and a processor or processors 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may be used to store all data and uses the equations and principles discussed herein to convert the data into usable data. The pertinent programs and executable code is contained in main memory 406 and is selectively accessed and executed in response to processor 404, which executes one or more sequences of one or more instructions contained in main memory 406. Such instructions may be read into main memory 406 from another computer-readable medium, such as storage device 410. One or more processors in a multi-processing arrangement may also be employed to execute the sequences of instructions contained in main memory 406. In alternative embodiments, hard-wired circuitry may be used in place of or in combination with software instructions and it is to be understood that no specific combination of hardware circuitry and software are required.

The instructions may be provided in any number of forms such as source code, assembly code, object code, machine language, compressed or encrypted versions of the foregoing, and any and all equivalents thereof. “Computer-readable medium” refers to any medium that participates in providing instructions to processor 404 for execution and “program product” refers to such a computer-readable medium bearing a computer-executable program. The computer usable medium may be referred to as “bearing” the instructions, which encompass all ways in which instructions are associated with a computer usable medium.

Computer-readable mediums include, but are not limited to, non-volatile media, volatile media, and transmission media. Non-volatile media include, for example, optical or magnetic disks, such as storage device 410. Volatile media include dynamic memory, such as main memory 406. Transmission media include coaxial cables, copper wire and fiber optics, including the wires that comprise bus 402. Transmission media may comprise acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various embodiments disclosed herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to the provided description without departing from the scope or spirit of the disclosure.

Other embodiments, uses and features of the present disclosure will be apparent to those skilled in the art from consideration of the specification and practice of the inventive concepts disclosed herein. The specification and drawings should be considered exemplary only, and the scope of the disclosure is accordingly intended to be limited only by the following claims.

1. A method for storing data to a flash array comprising the steps of:
sending a write request from a host computer to a solid state drive;
evicting the write request from a write buffer based on a dispatching policy, said dispatching policy configured to determine whether the write request is stored in an original form or a delta compressed faun;
writing the write request to a page mapping table when the write request is determined to be stored in the original form; and
inputting the write request and an old version from the page mapping table to a delta-encoding engine when the write request is determined to be stored in the delta compressed form, said delta-encoding engine derives and compresses a delta between the write request and the old version, wherein said old version corresponds to the write request.

2. The method of claim 1 further comprising the steps of:
buffering the delta in a temporary buffer; and
committing the delta to a delta log table when the temporary buffer is full.

3. The method of claim 2 further comprising the step of:
associating the delta in the delta log table with the old version that corresponds in the page mapping table.

4. The method of claim 2 further comprising the step of:
storing the page mapping table and the delta log table on the flash array,
wherein the delta the delta log table includes entries of the delta and the page mapping table includes entries of the old version.

5. The method of claim 4 further comprising the step of:
associating each of the entries in the delta log table and the page mapping table with a read access count and a write access count.

6. The method of claim 5, wherein said dispatching policy is configured to avoid inputting the write request and the old version to the delta-encoding engine when the write access count for entries corresponding to the delta and the old version is less than a predefined threshold.

7. The method of claim 5, wherein said dispatching policy is configured to avoid inputting the write request and the old version to the delta-encoding engine when the read access count for entries corresponding to the delta and the old version is greater than a predefined threshold.

8. The method of claim 5 further comprising the step of:
merging the delta and the old version corresponding to the delta when the read access count for entries corresponding to the delta and the old version is greater than a predefined threshold.

9. The method of claim 5 further comprising the step of:
merging the delta and the old version corresponding to the delta when the write access count for entries corresponding to the delta and the old version is no longer greater than a predefined threshold.
